(19) United States
(12) Patent Application Publication
(10) Pub. No.: US 2008/0085500 A1
(43) Pub. Date: Apr. 10, 2008

(54) Optical module for recognizing page of electronic book

(76) Inventors: Li-Hung Lai, Taichung (TW); Wen-Sheng Hsieh, Taichung (TW); Kun-Fang Huang, Taichung (TW)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/543,198

(22) Filed: Oct. 5, 2006

(51) Int. Cl. G09B 5/00

(52) U.S. Cl. 434/317

(57) ABSTRACT

The invention relates to an optical module for recognizing the pages of an electronic book. The optical module of the invention comprises: at least one light source, a plurality of pages, at least one light sensor and a page recognizing device. The light source is used for generating emitting light. Each page has a peripheral side for reflecting the emitting light. The light sensor is used for receiving the reflective light from the pages and outputting a corresponding signal, and the light source and the light sensor are mounted on the peripheral cover of the electronic book. The page recognizing device is used for recognizing a current page of the electronic book according to the corresponding signal. According to the invention, the different peripheral sides on the different pages are used to reflect the different reflective light, so that the electronic book can recognize the page which the user currently opens. Because the light sensor can be precisely controlled to receive the exact reflective light, the page recognizing device can precisely recognize the current page so as to solve the problem in the conventional electronic book.

### BACKGROUND OF THE INVENTION

1. Field of the Invention

The present invention relates to an optical module, more particularly, an optical module for recognizing the pages of an electronic book.

2. Description of the Related Art

Referring to FIG. 1, a conventional electronic book 10 comprises: a cover 11, a plurality of pages 12, 13, 14, a weighing sensor 15 and a page recognizing device 16. The weighing sensor 15 is mounted on the cover 11 of the electronic book 10, and is used to calculate the total weight of the pages on the weighing sensor 15. From the total weight of the pages, the page recognizing device 16 can recognize the page which the user currently opens. Therefore, the electronic book 10 can access and output the corresponding data from the memory according to the current page.

Nevertheless, because the weight of each page is light, the weighing sensor 15 must be accurate so as to precisely calculate the total weight of the pages. Therefore, the cost of the weighing sensor 15 must be expensive. Furthermore, if the user's hand touches the page or something is disposed on the page, the total weight calculated by the weighing sensor 15 may be wrong. The electronic book 10 may access and output the wrong corresponding data.

Therefore, it is necessary to provide an optical module for recognizing the pages of an electronic book so as to solve the above problem.

### SUMMARY OF THE INVENTION

One objective of the present invention is to provide an optical module for recognizing the pages of an electronic book. The optical module of the invention comprises: at least one light source, a plurality of pages, at least one light sensor, at least one filter, at least one shielding layer and a page recognizing device. The light source is used for generating emitting light and mounted on a peripheral cover of the electronic book. Each page has a peripheral side for reflecting the emitting light. The light sensor is used for receiving the reflective light from the pages and outputting a corresponding signal, and the light sensor is mounted on the peripheral cover of the electronic book. The filter is used for filtering surrounding light. The shielding layer is disposed between the light source and the light sensor, and is used for shielding the emitting light from the light source into the light sensor. The page recognizing device is used for recognizing a current page of the electronic book according to the corresponding signal.

According to the invention, the different peripheral sides on the different pages are used to reflect the different reflective light, so the electronic book can recognize the page which the user currently opens. Because the light sensor can be precisely controlled to receive the exact reflective light, the page recognizing device can precisely recognize the current page so as to solve the problem in the conventional electronic book.

### BRIEF DESCRIPTION OF THE DRAWINGS

FIG. 1 shows a convention electronic book having a weighing sensor for recognizing a current page.

FIG. 2 shows a top plan view of an electronic book having an optical module for recognizing a current page (a third page), according to a first embodiment of the invention.

FIG. 3A shows a side elevational view of the electronic book having the optical module for recognizing a current page (a second page), according to the first embodiment of the invention.

FIG. 3 shows a side elevational view of the electronic book having the optical module for recognizing a current page (a third page), according to the first embodiment of the invention.

FIG. 4 shows a top plan view of an electronic book having an optical module for recognizing a current page (a third page), according to a second embodiment of the invention.

FIG. 5 shows a side elevational view of the electronic book having the optical module for recognizing a current page (a third page), according to the second embodiment of the invention.

FIG. 6 shows a top plan view of an electronic book having an optical module for recognizing a current page, according to a third embodiment of the invention.

FIG. 7 shows a side elevational view illustrating that a circle shape emitting light is transformed to a line shape emitting light to enlarge the range of the emitting light, according to the third embodiment of the invention.

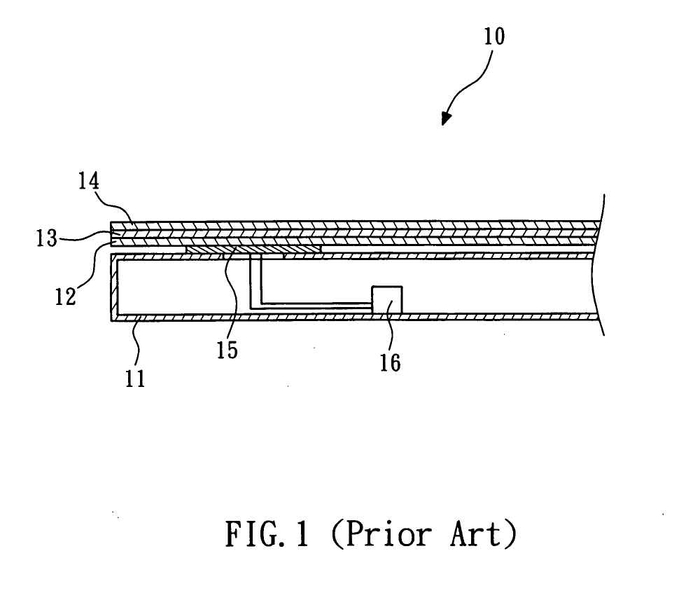

### DETAILED DESCRIPTION OF THE INVENTION

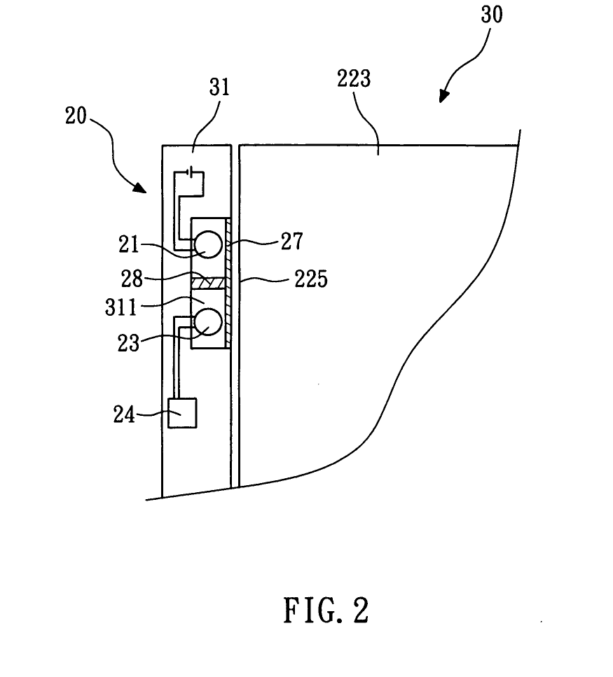

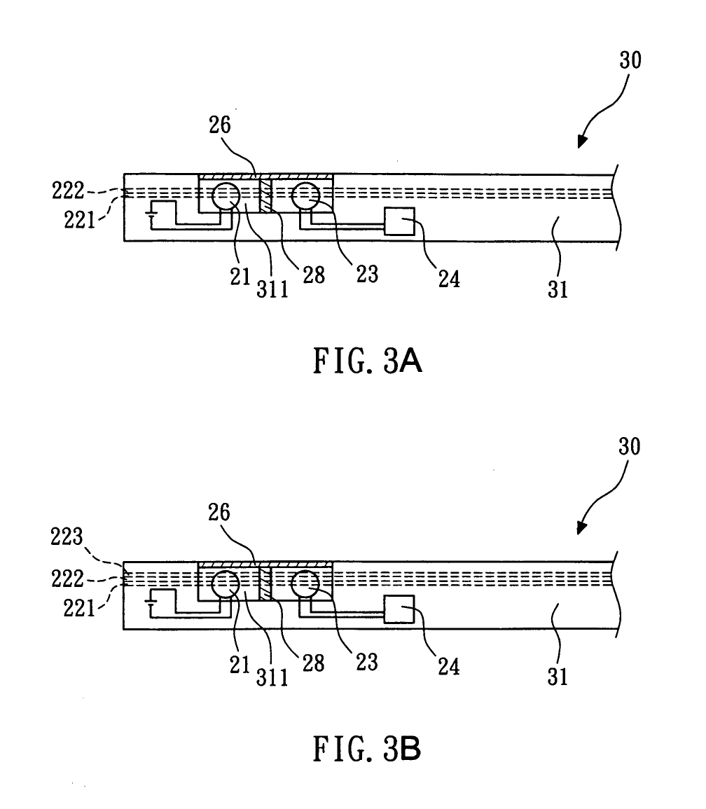

Referring to FIG. 2, FIG. 3A and FIG. 3B, they show an optical module for recognizing the pages of an electronic book, according to a first embodiment of the invention. The optical module 20 comprises: a light source 21, a plurality of pages 221, 222, 223, a light sensor 23, a page recognizing device 24, a first filter 26, a second filter 27 and a shielding layer 28. The light source 21 is used for generating emitting light and mounted on a peripheral cover 31 of the electronic book 30. The peripheral cover 31 is disposed at the periphery of the pages. Preferably, the emitting light is infrared light, and the light source may be a laser diode or a light emitting diode (LED). The peripheral cover 31 of the electronic book 30 comprises a slot 311 for containing the light source 21 and the light sensor 23.

Each page (the first page 221, the second page 222, the third page 223) has a peripheral side for reflecting the emitting light. For example, the third page 223 is a current page which the user opens. The third page 223 has a peripheral side 225 for reflecting the emitting light. The peripheral side may be a normal side of a page, or may comprise a reflecting metal layer or a reflective film for improving the reflection of the emitting light.

Referring to FIG. 3A, the light sensor 23 is used for receiving the reflective light from the pages 221, 222 and outputting a corresponding signal. When the second page 222 is opened to be a current page, the peripheral sides of the first page 221 and the second page 222 are used to reflect the emitting light. Referring to FIG. 3B, the light sensor 23 is used for receiving the reflective light from the pages 221, 222, 223 and outputting a corresponding signal. When the third page 223 is opened to be a current page, the peripheral sides of the first page 221, the second page 222 and the third page 223 are used to reflect the emitting light. Therefore, the reflective light from the peripheral sides of three pages is larger than that of two pages. The light sensor 23 can receive the different reflective light from the peripheral sides of the pages, and output the corresponding signal according to the reflective light. The light sensor may be a CMOS image sensor for clearly obtaining the reflective light.

The first filter 26 is disposed above the light source 21 and the light sensor 23, and is used for filtering the surrounding visible light. The second filter 27 is disposed between the light source 21, the light sensor 23 and the pages, and is used for filtering the surrounding visible light. The shielding layer 28 is disposed between the light source 21 and the light sensor 23, and is used for shielding the emitting light from the light source 21 and for preventing the emitting light from entering into the light sensor 23. According to the corresponding signal from the light sensor 23, the page recognizing device 24 can recognize a current page of the electronic book 30, for example the current page 223 in FIG. 3B. The electronic book 30 can access and output the corresponding data from the memory according to the current page.

According to the first embodiment of the invention, the different peripheral sides on the different pages are used to reflect the different reflective light, so the electronic book can recognize the page which the user currently opens. Because the light sensor can be precisely controlled to receive the exact reflective light, the page recognizing device can precisely recognize the current page so as to solve the problem of the wrong total weight of the pages in the conventional electronic book.

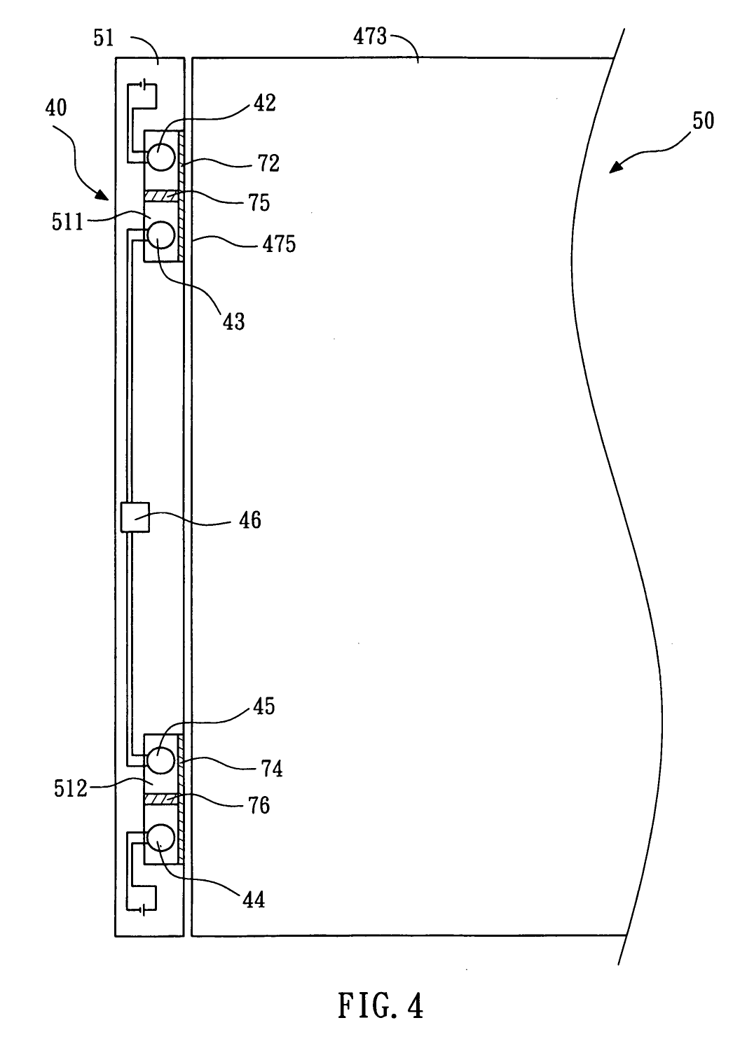

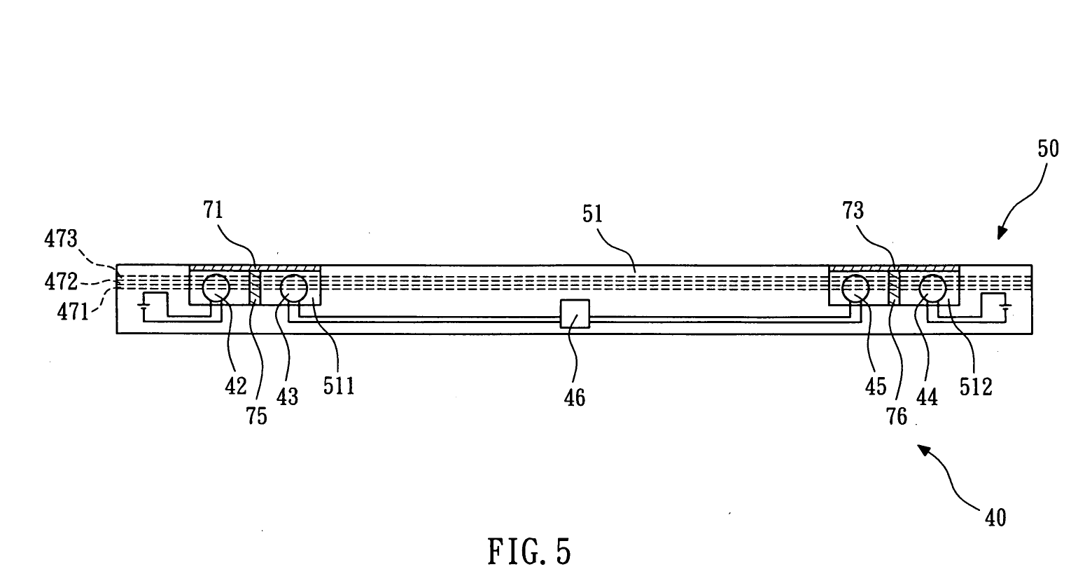

Referring to FIG. 4 and FIG. 5, they show an optical module for recognizing the pages of an electronic book, according to a second embodiment of the invention. The optical module 40 comprises: two light sources 42, 44, a plurality of pages 471, 472, 473, two light sensors 43, 45, a page recognizing device 46, four filters 71, 72, 73, 74 and two shielding layers 75, 76. The light sources 42, 44 are used for generating emitting light and mounted on a peripheral cover 51 of the electronic book 50. Preferably, The emitting light is infrared light. The peripheral cover 51 of the electronic book 50 comprises a first slot 511 and a second slot 512, the first slot 511 is used for containing a first light source 42 and a first light sensor 43, the second slot 512 is used for containing a second light source 44 and a second light sensor 45.

Each page (the first page 471, the second page 472, the third page 473) has a peripheral side for reflecting the emitting light. For example, the third page 473 is a current page which the user opens. The third page 473 has a peripheral side 475 for reflecting the emitting light from the first light source 42 and the second light source 44. The peripheral side may be a normal side of a page, or may comprise a reflecting metal layer or a reflective film for improving the reflection of the emitting light.

The first light sensor 43 is used for receiving the reflective light from a first portion (upper portion) of the peripheral sides of the pages 471, 472, 473 and outputting a first corresponding signal; the second light sensor 45 is used for receiving the reflective light from a second portion (bottom portion) of the peripheral sides of the pages 471, 472, 473 and outputting a second corresponding signal. In the second embodiment, there are two light sensors 43, 45 for doubly checking the reflective light so as to avoid the error.

The first filter 71 is disposed above the first light source 42 and the first light sensor 43, and the second filter 72 is disposed between the first light source 42, the first light sensor 43 and the pages. The first filter 71 and the second filter 72 are used for filtering the surrounding visible light. The first shielding layer 75 is disposed between the first light source 42 and the first light sensor 43, and is used for shielding the emitting light from the first light source 42 and for preventing the emitting light from entering into the first light sensor 43.

The third filter 73 is disposed above the second light source 44 and the second light sensor 45, and the fourth filter 74 is disposed between the second light source 44, the second light sensor 45 and the pages. The third filter 73 and the fourth filter 74 are used for filtering the surrounding visible light. The second shielding layer 76 is disposed between the second light source 44 and the second light sensor 45, and is used for shielding the emitting light from the second light source 44 and for preventing the emitting light from entering into the second light sensor 45.

According to the first corresponding signal from the first light sensor 43 and the second corresponding signal from the second light sensor 45, the page recognizing device 46 can exactly recognize a current page of the electronic book 50. The electronic book 50 can access and output the corresponding data from the memory according to the current page.

According to the second embodiment of the invention, the first light source 42, upper portions of the peripheral sides of the pages 471, 472, 473, the first light sensor 43, the first filter 71, the second filter 72 and the first shielding layer 75 are assembled to form a first set to obtain the first corresponding signal, and the second light source 44, bottom portions of the peripheral sides of the pages 471, 472, 473, the second light sensor 45, the third filter 73, the fourth filter 74 and the second shielding layer 76 are assembled to form a second set to obtain the second corresponding signal. Therefore, including the above advantage of the optical module 20 of the first embodiment, the optical module 40 can more precisely recognize the page which the user currently opens so as to avoid the error of the reflective light.

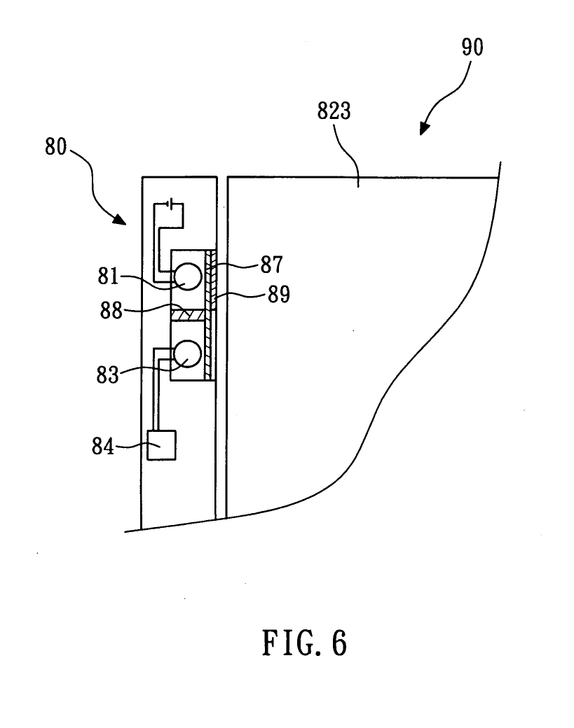

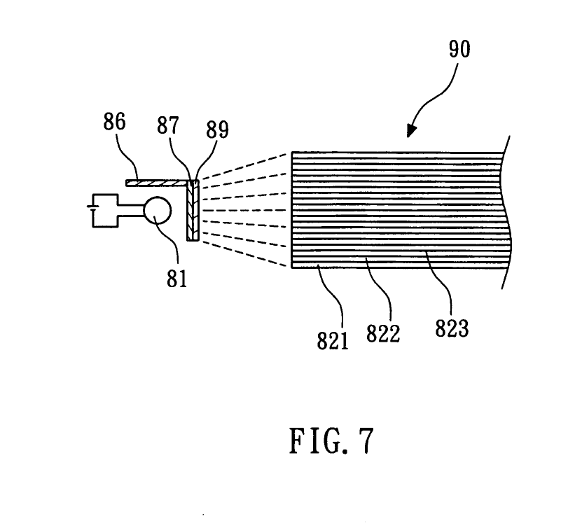

Referring to FIG. 6 and FIG. 7, they show an optical module for recognizing the pages of an electronic book, according to a third embodiment of the invention. The optical module 80 comprises: a light source 81, a plurality of pages 821, 822, 823, 824, a light sensor 83, a page recognizing device 84, a first filter 86, a second filter 87, a shielding layer 88 and a line lens 89. Compared with the optical module 20 of the first embodiment, the optical module 80 of the third embodiment further comprises the line lens 89.

When the thickness of the electronic book 90 is larger than that of the light source 81, the peripheral sides of the pages above or below the light source 81 cannot receive and reflect the emitting light without the line lens 89. The line lens 89 can be used for transforming a circle shape emitting light from the light source 81 to a line shape emitting light so as to enlarge the range of the emitting light. Therefore, after the line lens 89, the line shape emitting light can emit to the peripheral sides of the whole pages. The peripheral sides of the whole pages can reflect the emitting light, and the light sensor 83 can receive exact reflective light to output exact corresponding signal for recognizing a current page.

While several embodiments of the present invention have been illustrated and described, various modifications and improvements can be made by those skilled in the art. The embodiment of the present invention is therefore described in an illustrative, but not restrictive, sense. It is intended that the present invention may not be limited to the particular forms as illustrated, and that all modifications which maintain the spirit and scope of the present invention are within the scope as defined in the appended claims.

What is claimed is:

1. An optical module for recognizing the pages of an electronic book, comprising:
at least one light source, for generating emitting light and mounted on a peripheral cover of the electronic book;
a plurality of pages, each page having a peripheral side for reflecting the emitting light;
at least one light sensor, for receiving the reflective light from the pages and outputting a corresponding signal, the fight sensor mounted on the peripheral cover of the electronic book;
at least one filter, for filtering surrounding light;
at least one shielding layer, disposed between the light source and the light sensor, for shielding the emitting light from the light source into the light sensor; and
a page recognizing device, for recognizing a current page of the electronic book according to the corresponding signal.

2. The optical module according to claim 1, wherein the emitting light is infrared light.

3. The optical module according to claim 1, wherein the peripheral cover of the electronic book comprises at least one slot for containing the light source and the light sensor.

4. The optical module according to claim 3, wherein the peripheral cover of the electronic book comprises a first slot and a second slot, the first slot is used for containing a first light source and a first light sensor, and the second slot is used for containing a second light source and a second light sensor.

5. The optical module according to claim 1, wherein the filters comprises a first filter and a second filter, the first filter and the second filter are used for filtering the surrounding visible light, the first filter is disposed above the light source and the light sensor, and the second filter is disposed between the light source, the light sensor and the pages.

6. The optical module according to claim 1, wherein the light source is a laser diode.

7. The optical module according to claim 1, wherein the light sensor is a CMOS image sensor.

8. The optical module according to claim 1, further comprising a line lens for transforming a circle shape emitting light from the light source to a line shape emitting light.
